(19) United States
(12) Patent Application Publication
(10) Pub. No.: US 2013/0073297 A1
(43) Pub. Date: Mar. 21, 2013

(54) METHODS AND DEVICES FOR PROVIDING AN ENCODED DIGITAL SIGNAL

(71) Applicants: Rongshan Yu, Singapore (SG); Te Li, Singapore (SG); Haiyan Shu, Singapore (SG); Susanto Rahardja, Singapore (SG)

(72) Inventors: Rongshan Yu, Singapore (SG); Te Li, Singapore (SG); Haiyan Shu, Singapore (SG); Susanto Rahardja, Singapore (SG)

(73) Assignee: AGENCY FOR SCIENCE, TECHNOLOGY AND RESEARCH, Singapore (SG)

(21) Appl. No.: 13/637,257

(22) PCT Filed: Mar. 23, 2011
(86) PCT No.: PCT/SG2011/000112

§ 371 Date: Dec. 4, 2012

(30) Foreign Application Priority Data
Mar. 26, 2010 (SG) 201002108-7

(51) Int. Cl. G10L 19/00

(52) U.S. Cl. CPC G10L 19/00
USPC 704/500

(57) ABSTRACT

In one embodiment, a method for providing an encoded digital signal is described comprising determining, for each data frame of a plurality of data frames of a digital signal, a plurality of pairs of an encoding data volume and an encoding quality, wherein each pair of an encoding data volume and an encoding quality specifies the encoding data volume required for achieving the encoding quality; determining for each data frame at least one or more interpolations between the plurality of determined pairs; determining a multi-frame relationship between encoding quality and encoding data volume required to encode the plurality of data frames at the encoding quality based on a combination of the at least one or more interpolations for the plurality of data frames; determining an encoding quality for the plurality of data frames based on the relationship; and providing at least one data frame of the plurality of data frames encoded at the determined encoding quality.

### FIELD OF THE INVENTION

Embodiments of the invention generally relate to methods and devices for providing an encoded digital signal.

### BACKGROUND OF THE INVENTION

Audio streaming typically refers to constantly distributing audio content over a communication network from a streaming provider to an end-user. Usually, the audio content is compressed to a lower data rate (compared to the data rate of the original audio content) prior to streaming by using an audio coding technology so that the communication network bandwidth can be used efficiently.

Typically, in an audio encoder, audio content is segmented into a sequence of audio frames of constant time duration (referred to as frame length), and the audio frames are further processed so that redundancies and/or irrelevant information are removed from the audio frames, resulting in a compressed audio bit-stream with reduced data rate compared to the data rate of the original audio content.

Traditional audio codecs such as mp3 or MPEG-4 AAC produce a Constant Bit-Rate (CBR) bit stream that consists of compressed audio frames of equal size throughout the audio content. Due to the non-stationary or unstationary nature of audio signals, a CBR audio bit-stream typically exhibits quality fluctuation at multi time scales. As a result, streaming of CBR audio may result in unstable quality which is perceptually annoying to the end user and poor perceptual quality at critical frames of audio signal, i.e., audio frames requiring more transmission bits to achieve the same quality compared with other frames of the audio signal.

This may be addressed using a Variable Bit-Rate (VBR) audio codec which generates variable bit-rate, but constant quality bit-streams. However, although VBR coding can be used to avoid quality fluctuation, VBR audio is in general not communication network friendly as the bit rate fluctuation of VBR encoded audio signals is typically content dependent and fixed after the encoding process. Therefore, it can conflict with actual available resource of the communication network during streaming.

The introduction of Fine Granular Scalable (FGS) audio coding such as MPEG-4 Scalable to Lossless (SLS) coding may allow solving the above issues.

Unlike other audio codecs the compressed audio frames produced by an FGS encoder can be further truncated to lower data rates at little or no additional computational cost. This feature allows an audio streaming system to adapt the streaming quality/rate in real-time depending on both the available bandwidth for streaming and the criticalness of the audio frames being streamed so that both constant quality streaming and network, friendliness may be achieved.

Efficient methods for controlling FGS encoding with regard to the achieved audio quality and available bandwidth usage are desirable.

Documents [1] and [2] describe rate-quality models based on pre-measured data points and linear interpolation for rate control of video coding and adaptive FGS video streaming, respectively. The method of [2] relies on iterative bisectional search, which has relatively high computational complexity.

In document [3] an idea on constant quality adaptive streaming has been proposed for video streaming wherein the target quality selection is over the entire media file. The rate-quality model, which is based on parameterized non-linear functions, is customized for naïve MSE quality measure for video/image in general.

### SUMMARY OF THE INVENTION

In one embodiment, a method for providing an encoded digital signal is provided including determining, for each data frame of a plurality of data frames of a digital signal, a plurality of pairs of an encoding data volume and an encoding quality, wherein each pair of an encoding data volume and an encoding quality specifies the encoding data volume required for achieving the encoding quality; determining for each data frame at least one or more interpolations between the plurality of determined pairs; determining a multi-frame relationship between encoding quality and encoding data volume required to encode the plurality of data frames at the encoding quality based on a combination of the at least one or more interpolations for the plurality of data frames; determining an encoding quality for the plurality of data frames based on the relationship; and providing at least one data frame of the plurality of data frames encoded at the determined encoding quality.

### SHORT DESCRIPTION OF THE FIGURES

Illustrative embodiments of the invention are explained below with reference to the drawings.

FIG. 1 shows a flow diagram according town embodiment.

FIG. 2 shows a device for providing an encoded digital signal according to an embodiment.

FIG. 3 shows a communication arrangement according to an embodiment.

FIG. 4 shows frame structures according to an embodiment.

FIG. 5 shows a flow diagram according to an embodiment.

FIG. 6 shows a quality-bit rate diagram according town embodiment.

FIG. 7 shows an encoding data volume-encoding quality diagram according to an embodiment.

FIG. 8 shows a data rate-time diagram.

FIG. 9 shows a communication arrangement according to an embodiment.

FIG. 10 shows a flow diagram according to an embodiment.

FIG. 11 shows a device for providing an encoded digital signal.

FIG. 12 shows a communication arrangement according to an embodiment.

### DETAILED DESCRIPTION

According to one embodiment, an adaptive streaming system (specifically an encoder, e.g. being part of a transmitter and an encoding method) for FGS audio is provided that maintains a constant quality streaming as much as possible while at the same time fully utilizing the bandwidth available for the streaming.

To this end, according to an embodiment, a target quality is first selected, and the sizes of the audio frames to be streamed are truncated accordingly so that this target quality is achieved.

To ensure best possible quality of the streamed audio while at the same time not to over-utilize the network resource, according to one embodiment a target encoding quality is selected such that the rate of the truncated bit-stream, on average, is within the constraint of available network bandwidth for the streaming. In order to effectively determine the target quality and the sizes of the truncated audio frames the adaptive streaming server (i.e. the transmitter or the encoder) is according to one embodiment made aware of the rate-quality relationship (i.e. the relationship between the encoding rate and the encoding quality achieved with the encoding rate) of the audio to be streamed at the audio frame level. This rate-quality relationship may be highly non-uniform and highly dynamic in general. As a result, it may not be easy to convey this information to the streaming server.

According to one embodiment, the streaming server (specifically a data rate (or encoding data volume) controller) is provided with the rate-quality relationship of the audio to be streamed by using a rate-quality model based on pre-measured data points and linear interpolation. This rate-quality model allows highly effective adaptive streaming at low complexity.

According to one embodiment, a sliding window is introduced so that the target quality selection can be seen to be “localized” to audio frames from a window of limited duration (e.g. in terms of a certain number of frames). The introduction of the sliding window can be seen to localize bit-rate fluctuation of the streamed audio so that it is more accommodating with available network bandwidth estimated during streaming.

Further, according to one embodiment, a pre-measured rate-quality table based model is used which is suitable for FGS audio and leads to an easy solution for the problem of selecting the target encoding quality/data rate for streaming.

According to one embodiment, a rate-quality model is used based on piece-wise linear functions and a closed-form low-complexity solution far selecting the target quality/rates for streaming is used. This allows lower computational complexity than for example using a Newton search algorithm.

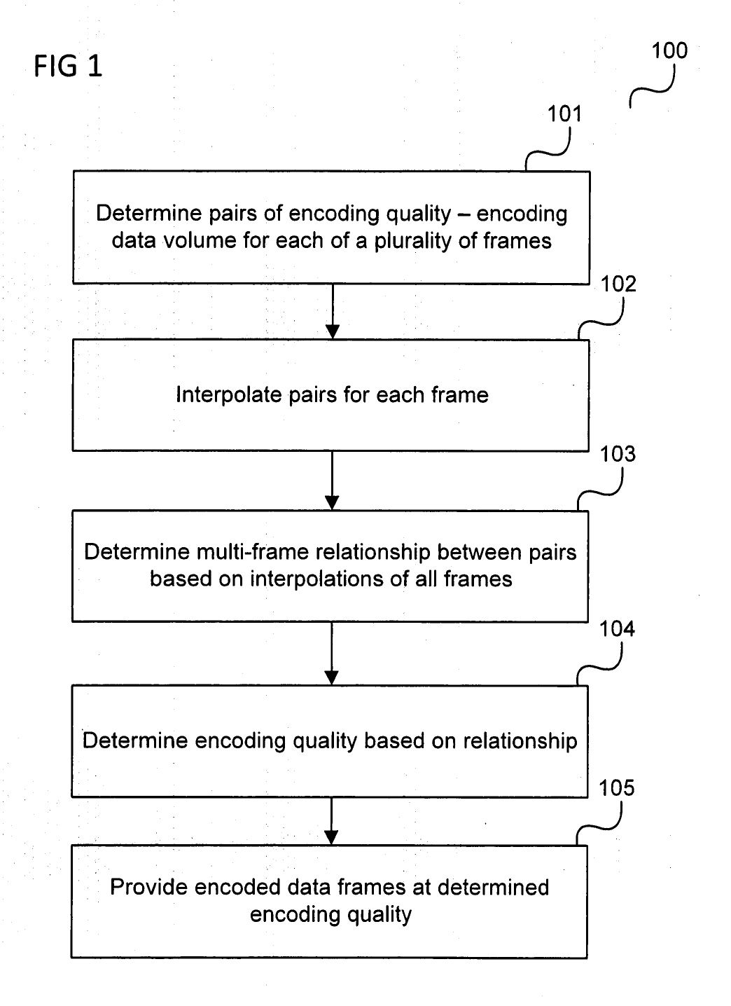

A method for providing an encoded digital signal according to an embodiment is illustrated in FIG. 1.

FIG. 1 shows a flow diagram 100 according to an embodiment.

The flow diagram 100 illustrates a method for providing an encoded digital signal.

In 101, for each data frame of a plurality of data frames of digital signal, a plurality of pairs of an encoding data volume and an encoding quality are determined, wherein each pair of an encoding data volume and an encoding quality specifies the encoding data volume required for achieving the encoding quality.

In 102, for each data frame at least one or more interpolations between the plurality of determined pairs are determined.

In 103, a multi-frame relationship between encoding quality and encoding data volume required to encode the plurality of data frames at the encoding quality is determined based on a combination of the at least one or more interpolations for the plurality of data frames.

In 104, an encoding quality for the plurality of data frames is determined based on the relationship.

In 105 at least one data frame of the plurality of data frames is provided encoded at the determined encoding quality.

According to one embodiment, in other words, approximations for the dependence between encoding data volume and encoding quality for each of a plurality of frames are determined by interpolation of pre-determined (e.g. measured) pairs of encoding data volume and encoding quality. These approximations are combined to have a multi-frame dependence between encoding data volume and encoding quality, i.e. dependence between encoding data volume and encoding quality for the whole plurality of data frames. This overall dependence is then used to determine an encoding quality to be used for the frames (or at least a part of the frames until the encoding quality to be used is re-determined, e.g. on a periodic basis).

The digital signal is for example a media data signal, such as an audio or a video signal.

According to one embodiment the relationship specifies for each encoding quality of a plurality of encoding qualities a corresponding encoding data volume required to encode the plurality of data frames at the encoding quality.

According to one embodiment the encoding quality for the plurality of data frames is determined such that the encoding data volume corresponding to the determined encoding quality according to the relationship fulfils a predetermined criterion.

According to one embodiment the criterion is that the encoding data volume is below a pre-determined threshold.

According to one embodiment the threshold is based on a maximum data rate.

According to one embodiment the multi-frame relationship is determined based on a combination of the at least one or more interpolations for at least two different data frames of the plurality of data frames.

According to one embodiment the at least one interpolation of a data frame of the plurality of data frames is an interpolation of the plurality of encoding data volume and encoding quality pairs of the data frame.

According to one embodiment the at least one interpolation of a data frame of the plurality of data frames is a linear interpolation of the plurality of encoding data volume and encoding quality pairs of the data frame.

According to one embodiment the plurality of data frames is a plurality of successive data frames.

According to one embodiment the at least one data frame of the plurality of data frames provided encoded at the determined encoding quality includes the first data frame of the plurality of successive data frames encoded at the determined encoding quality.

The method may further include determining a further encoding quality to be used for a further plurality of successive data frames including the plurality of data frames without the at least one data frame provided encoded at the determined encoding quality.

According to one embodiment each interpolation of the at least one or more interpolations between the plurality of determined pairs for a data frame is an interpolated pair of an encoding data volume and an encoding quality specifying the encoding data volume required for achieving the encoding quality for the data frame.

According to one embodiment the multi-frame relationship is determined based on a summing of the encoding data volumes required for achieving an encoding quality for different data frames for the same encoding quality.

According to one embodiment the result of the summing is specified by the relationship for an encoding quality as a corresponding encoding data volume required to encode the plurality of data frames at the encoding quality.

According to one embodiment the multi-frame relationship is a piecewise linear correspondence between encoding quality and encoding data volume required to encode the plurality of data frames at the encoding quality.

According to one embodiment the plurality of pairs of an encoding data volume and an encoding quality for each data frame are generated by measuring, for each of a plurality of encoding data volumes, the encoding quality achieved when encoding the data frame using the encoding data volume.

According to one embodiment the digital signal is an audio signal.

It should be noted that, as in the example described below, providing an encoded frame at a quality may include having a frame encoded at a higher quality (e.g. stored in a memory) and reducing the quality of the frame encoded at the higher quality e.g. by truncating the frame encoded at the higher quality.

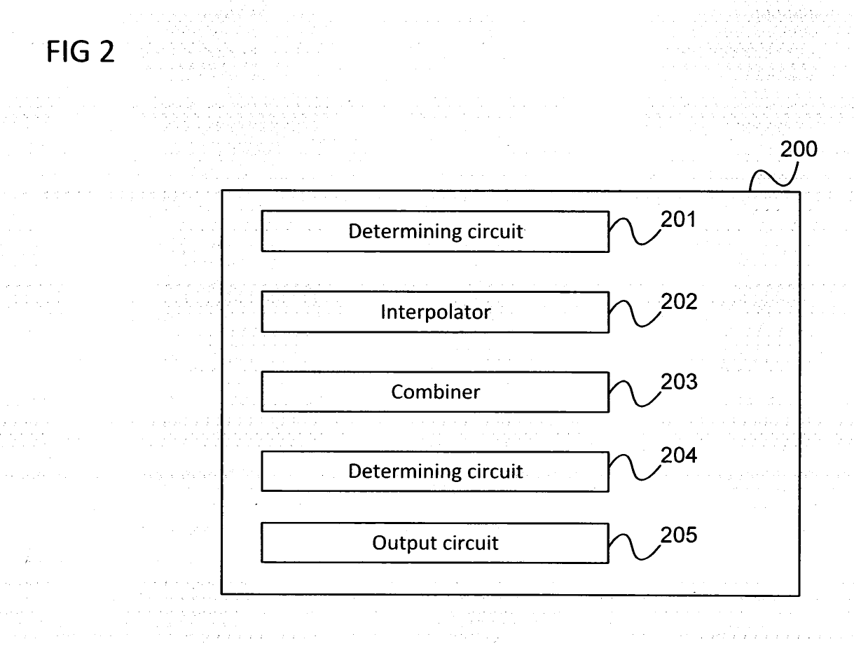

The method illustrated in FIG. 1 is for example carried out by a device as illustrated in FIG. 2.

FIG. 2 shows a device for providing an encoded digital signal 200 according to an embodiment.

The device 200 includes a first determining circuit 201 configured to determine, for each data frame of a plurality of data frames of a digital signal, a plurality of pairs of an encoding data volume and an encoding quality, wherein each pair of an encoding data volume and an encoding quality specifies the encoding data volume required for achieving the encoding quality.

Further, the device 200 includes an interpolator 202 configured to determine for each data frame at least one or more interpolations between the plurality of determined pairs and a combiner 203 configured to determine a multi-frame relationship between encoding quality and encoding data volume required to encode the plurality of data frames at the encoding quality based on a combination of the at least one or more interpolations for the plurality of data frames.

The device 200 further includes a second determining circuit 204 configured to determine an encoding quality for the plurality of data frames based on the relationship and an output circuit 205 providing at least one data frame of the plurality of data frames encoded at the determined encoding quality.

The device 200 is for example part of a server computer (e.g. a streaming server (computer)) providing encoded data, e.g. encoded media data such as encoded audio data or encoded video data.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment. Further, it should be noted that different circuits may be implemented by the same circuitry, e.g. by only one processor.

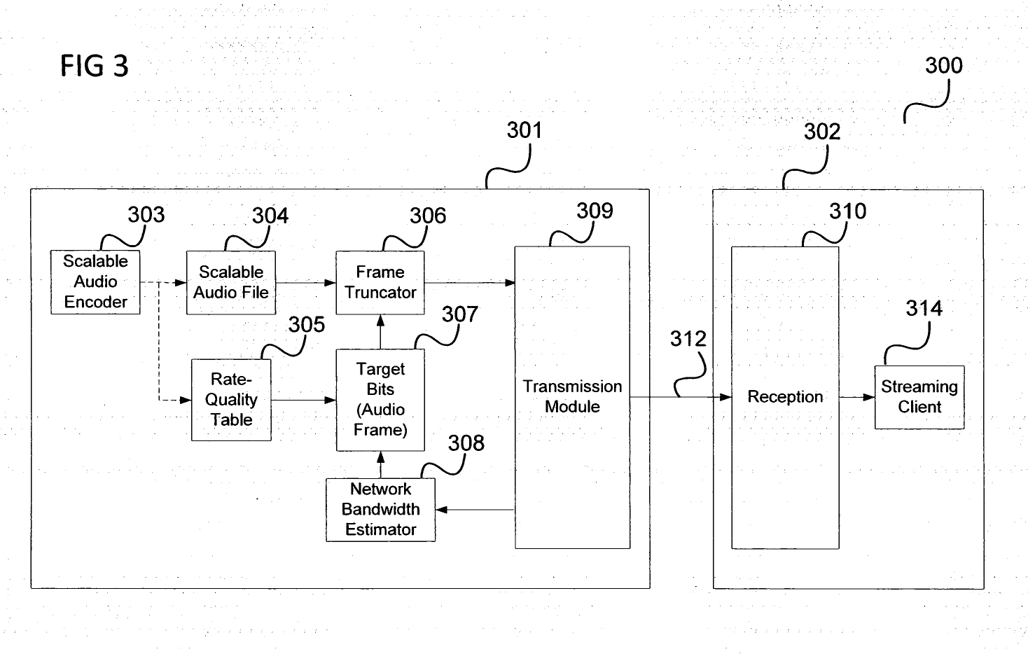

An adaptive streaming system according to an embodiment, for example including a device as shown in FIG. 1 on the transmitter side is described in the following with reference to FIG. 3.

FIG. 3 shows a communication arrangement 300 according to an embodiment.

The communication arrangement 300 includes a transmitter 301 and a receiver 302. The transmitter 301 includes a scalable audio encoder 303 providing a scalable audio file 304 and a rate-quality table 305. The transmitter 301 further includes a frame truncator 306 receiving the scalable audio file 304 as input and a rate controller 307 receiving the rate-quality table 305 as input. The transmitter 301 further includes a network bandwidth estimator 308 and a transmitting module 309. The receiver 302 includes a receiving module 310 and a streaming client 311. The streaming client 311 may for example be a software application running on the receiver 302 for playing audio to the user of the receiver 302.

The transmitter 301 streams encoded audio content at a certain encoding quality to the receiver 302 over a communication network 312, e.g. via a computer network such as the Internet or via a radio communication network such as a cellular mobile communication network, to the receiver 302.

The audio content is transmitted in a plurality of encoded audio frames, wherein each audio frame is encoded at a certain encoding quality.

The rate controller 307 selects the target encoding quality of the audio frames based on information from both the rate-quality table 305 and the available network bandwidth of the communication network 312 estimated by the network bandwidth estimator 308. Once the target quality is selected, the scalable audio file 304 is truncated accordingly, and sent to via the communication network 312 for streaming to the receiver (and ultimately to the streaming client 311).

The scalable audio file 304 may be provided by the scalable audio encoder 303, e.g. from audio content supplied to the transmitter 301. However, it should be noted that the scalable audio file 304 may also be pre-stored in the transmitter 312, i.e. the scalable audio encoder 303 does not need to be part of the transmitter.

Examples for the detailed implementation of components of the transmitter 301 and the receiver 302 are described in more detail in the following.

The scalable audio file 304 may include the audio content to be streamed at high (or even lossless) quality. According to one embodiment, the scalable audio file 304 (including the audio content to be streamed, e.g. at high quality) is encoded according to MPEG-4 scalable lossless (SLS) coding. MPEG-4 scalable lossless (SLS) coding was released as a standard audio coding tool in June 2006. It allows the scaling up of a perceptually coded representation such as MPEG-4 AAC to a lossless representation with a wide range of intermediate bit rate representations.

One of the major merits of a FGS audio codec like MPEG-4 SLS can be seen in that the bit-stream generated by the encoding can be further truncated to lower data rates.

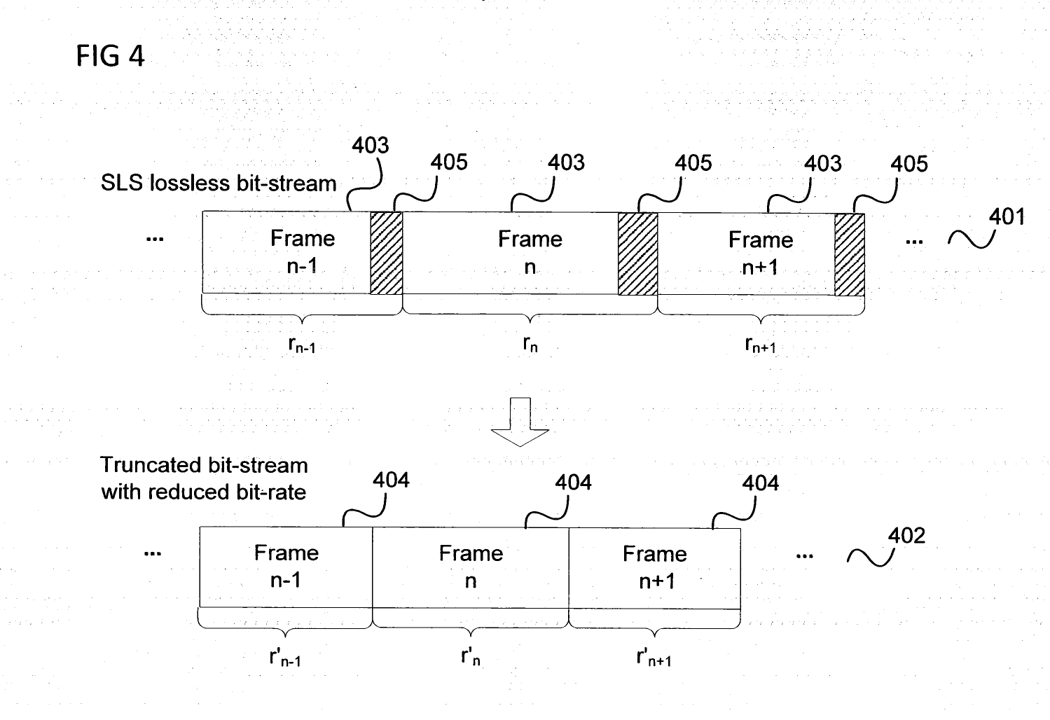

This is illustrated in FIG. 4.

FIG. 4 shows a first frame structure 401 and a second frame structure 402.

The first frame structure 401 for example corresponds to the scalable audio file 304 (e.g. is contained in the audio file 304) and second frame structure 402 for example corresponds to the output of the truncator 306.

The first frame structure 401 includes data for a plurality of losslessly encoded frames 403 and the second frame structure 401 includes data for a plurality of lossy encoded frames 404 (as an example three frames numbered from n−1 to n+1 are illustrated in this example).

Data sections 405 may be removed from the data of the losslessly encoded frames 403 to generate the data of the lossy encoded frames 404. The data section 405 of the data for a losslessly encoded frame 403 is for example an, end section of the data (which are for example in the form of a bit-stream) for the losslessly encoded frame 403 such that the data for the losslessly encoded frame 403 may be simply truncated (e.g. by frame truncator 306) to generate the data for the lossy encoded frame 404.

The truncation can be done at any stage between the provider of the lossless bit-stream (e.g. included in first frame structure 401) and the streaming client (e.g. at a server or at a communication network gateway) and requires little computational resources. This merit may be particularly relevant for a streaming server or gateway that needs to handle large numbers of simultaneous streaming sessions.

For example, the first frame structure 401 includes a Lossless SLS bit-stream with frame size rn where n is the frame index and the second frame structure 402 includes the truncated SLS bit-stream with reduced bit-rate r′n. The truncation operation of SLS is done by simply dropping the end of each SLS frame of certain length from the SLS bit-stream of higher bit-rates (i.e. the data sections 405) according to the desired quality/rate of the truncated SLS bit-stream.

According to one embodiment, this possibility of truncation in FGS audio is used whereby the full-fidelity FGS audio (i.e. the losslessly or high quality encoded audio content as included in the scalable audio file 304) is truncated to lower data rates according to available bandwidth and quality demands before it is sent via the communication network 312 for streaming. It should be noted that MPEG-4 SLS is used as an example and embodiments are not limited to MPEG-4 SLS as scalable encoding process used for generating the scalable audio file 304.

According to one embodiment, the rate controller 307 determines the data rate of the encoded audio stream sent by the transmitter 301. Specifically, according to one embodiment, the rate controller 307 determines the sizes of the streamed FGS (encoded) audio frames based on a rate-quality relationship of the audio frames as well as the available network bandwidth. For this, according to one embodiment, the rate-quality table 305 is used.

The rate-quality relationship of the audio frames for example gives for each audio frame and each encoding quality of the audio frame the required encoding data rate (or, equivalently in case of a fixed frame rate, the encoding data volume) to achieve this encoding quality.

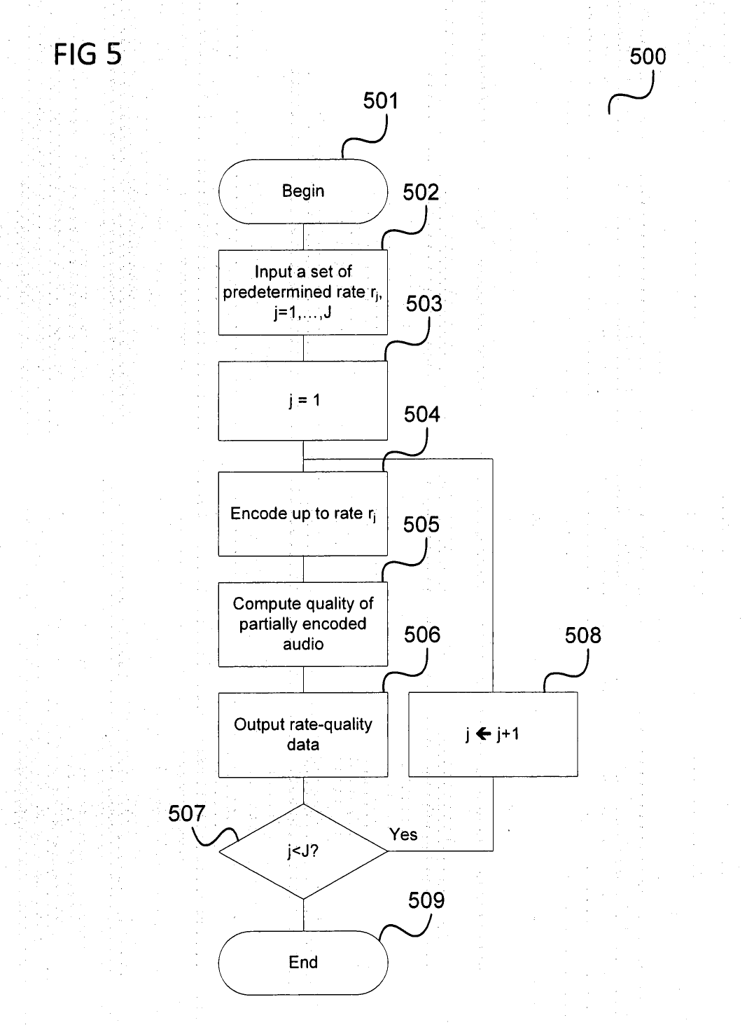

The detailed process for generating the rate-quality table according to one embodiment is illustrated in FIG. 5.

FIG. 5 shows a flow diagram 500 according to an embodiment.

The flow illustrates a process of constructing the rate-quality table 305 according to an embodiment.

As can be seen from the flow diagram 500, the process of constructing the rate-quality table 305 can be integrated with the encoding process of FGS audio, i.e. with the generation of the scalable audio file 304 generated by the scalable audio encoder 303. Accordingly, according to one embodiment (and as illustrated in FIG. 3) the scalable audio encoder 303 generates the scalable audio file 304.

The process is started for a frame in 501. In 502, a set of predetermined encoding data volumes rᵢ, i=1, . . . , n (which can be seen to correspond to a data rate for the frame for a certain frame rate) are input.

In 502, a counter indicated by counter variable j is set to 1.

In 504, the frame is encoded such that the encoded frame has the data volume rⱼ.

In 505, the quality of the encoded audio frame is determined.

In 506, the pair of the data volume rⱼ and the determined quality is output as entry into the rate-quality table 305.

In 507, it is checked whether j<J (i.e. whether the last encoding data volume has not already been reached in the process). If j<J, j is increased by one and the process continues with 504. If j=J, the process is ended (for this frame) in 509.

The process illustrated in FIG. 5 can be seen to include, during the encoding process, monitoring the size of the compressed (i.e. encoded) audio frame encoded so far and once the size is matches a certain pre-determined criterion, e.g., a pre-determined data rate rⱼ, computing the quality of the partially encoded audio frame, i.e., the quality of the resulting audio frame after decoding the encoded audio frame if the audio frame is encoded using the pre-determined data rate rⱼ (e.g. is truncated from the losslessly encoded audio frame to the size corresponding to rⱼ), and storing the computed quality together with the pre-determined data rate (or size) into the rate-quality table 305.

According to one embodiment, the process as described above with reference to FIG. 5 is performed for every audio frame during the encoding process. The resulting rate-quality table 305 may then be stored together with the scalable audio file 304, and may be used by the transmitter 301 (e.g. an audio streaming server) for the truncation process carried out by the frame truncator 306.

According to one embodiment, the data stored in the rate-quality table 305 resides only on the server side and is not sent to the receiver 302. Thus, these data do not increase the burden on the communication network 312 for the streaming process.

The encoding quality of an encoded audio frame is for example calculated as the minimum value of the Masking-to-Noise Ratios (MNRs) of all scale factor bands (sfb) for which the audio frame includes data. Other quality metrics (or measures) may be used.

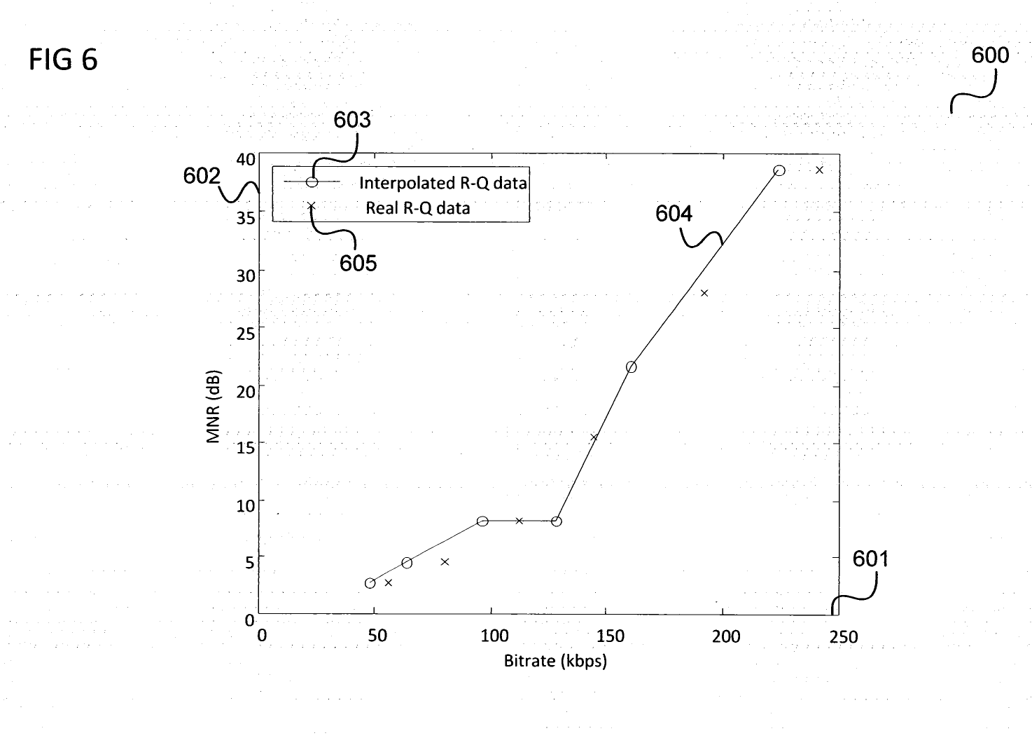

Since the rate-quality table 305 generated according to the process explained above with reference to FIG. 5 only records a limited number of rate-quality points (i.e. pairs of encoding data rate (or encoding data volume) and encoding quality), the rate-quality points not recorded in the rate-quality table 305 are according to one embodiment determined by linear interpolation. This is for example done by the audio streaming server, e.g. by the rate controller 307 of the transmitter 301. This is illustrated in FIG. 6.

FIG. 6 shows a quality-bit rate diagram 600 according to an embodiment.

The bit rate (as example for data rate) is given by a first axis 601 in kbps (kilobits per second) and the quality is given in dB (decibel) as the masking to noise ratio.

Circles 603 indicate points (i.e. quality-data rate pairs) that have been determined for a frame, for example in the process illustrated in FIG. 5. A line 604 indicates the approximation of points determined by linear interpolation of the determined points. In other words, the line 604 indicates an interpolated piecewise linear quality-rate (or rate-quality) function for the frame generated from the determined quality-data rate pairs.

Crosses 605 indicate actual quality-data rate pairs for the frame.

As can be seen from the diagram 600 the linear interpolation is only an approximation of the actual rate-quality function and it introduces approximation error for “real” points (which are marked by the crosses 605) in-between the interpolation points (Marked by the circles 604).

In practical application, the approximation error is usually tolerable if the density of the data points for interpolation is carefully chosen. Further, as shown below, the linearly interpolated rate-quality function can be used to simplify the determination of a (target) encoding quality to be used for a rate-quality optimized audio streaming solution, namely to solving linear equations.

In the following it is explained how the rate controller 307 may derive the target encoding quality based on the rate-quality table 305 and the available bandwidth estimated by the bandwidth estimator 308. Assuming a rate quality table 305 of n different encoding data volumes (or, equivalently for a certain frame rate, encoding rate) rᵢ, i=1, . . . , n where rᵢ is the audio frame size. The quality of frame j at encoding rate rᵢ is denoted as Let r̅ⱼ (q) be the interpolated rate-quality function of frame j generated from the points (rᵢ, q_{i,j}) as explained with reference to FIG. 6. The goal of the rate controller 307 is to find a target encoding quality q_{T} for the streaming to follow in at least a period of time (e.g. to use for a certain number of frames), for example until the network situation is changed, e.g. the bandwidth constraint given by the communication network 312 for the streaming changes. To this end, according to one embodiment, a sliding look-ahead window is used and a constant quality streaming is kept within this look-ahead window under the available bandwidth constraint. In the following, it is assumed that the available streaming bit budget for a look-ahead window (j₀, j₀+L) is R_{N}, where j₀ is the index of the current frame and L is the length of the look-ahead window. In other words, R_{N} bits are available for transmitting the L frames of the sliding window (e.g. according to the bandwidth constraint imposed by the current capacity of the communication network 312).

The aggregated R-D (rate distortion) function is defined as

$$R ( q ) = {\sum }_{j = {j}_{0}}^{{j}_{0} + L - 1} {\overline{r}}_{j} ( q ) . \qquad ( 1 )$$

The aggregated R-D function can be seen as a multi-frame relationship between the encoding quality and encoding data rate (or encoding data volume) for a plurality of frames (namely the L frames of the sliding window) determined based on a combination of the rate-quality functions for the frames of the sliding window (specifically, in this example, a sum of the rate-quality functions for the frames of the sliding window).

According to one embodiment, the target quality is determined by the rate controller 307 according to the following equation:

R(q_{T})=R_{N}. (2)

Since r̅ⱼ(q) are piece-wise linear functions as a result of the linear interpolation, R(q) is a piece-wise linear function as well. As a result, equation (2) is a linear equation and its solution is straightforwardly given by:

$${q}_{T} = \frac{{R}_{N} - {R}_{L}}{{R}_{H} - {R}_{L}} {q}_{L} + \frac{{R}_{H} - {R}_{N}}{{R}_{H} - {R}_{L}} {q}_{H} \qquad ( 3 )$$

where R_{L} and R_{H} are, respectively, lower and upper ends of the linear segment of R(q) in which R_{N} is located, and q_{L} and q_{H} the corresponding qualities. Once the target quality is obtained the size of each streamed audio frame (i.e. the encoding data volume for each audio frame of the sliding window) is selected from the interpolated rate-quality function as r̅ⱼ(q_{T}). The frame truncator 306 truncates the data for the audio frames of the sliding window included in the scalable audio file 304 according to this encoding data size.

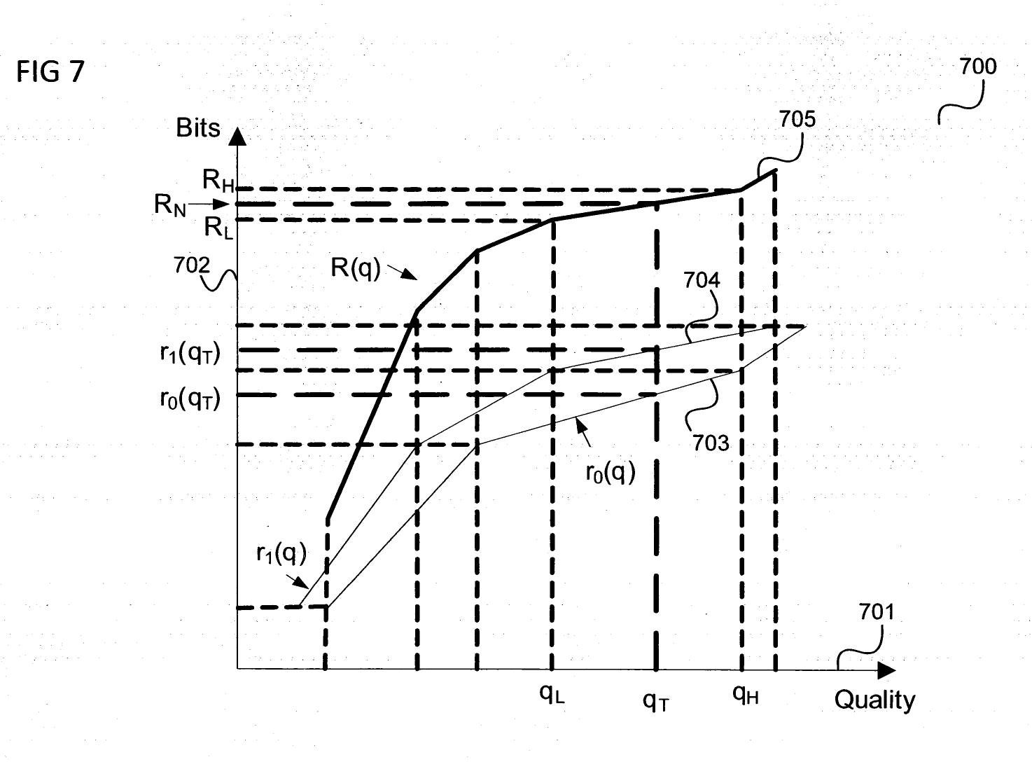

The calculation according to equation (3) is illustrated in FIG. 7.

FIG. 7 shows an encoding data volume-encoding quality diagram 700 according to an embodiment.

The quality increases along a first axis 701 and is given as a value for parameter q. This may for example be a measure of the mask-to-noise ratio or the value of a quantization parameter (e.g. an accuracy of the quantization which is done when truncating the encoding data or encoding bit-stream of a frame). The encoding data volume increases along a second axis 602 and is for example given in bits.

In this example, it is assumed that the sliding window has only two audio frames (i.e. L=2). As shown, a first (interpolated) rate-quality function 703 for a first frame (j=j₀) and a second (interpolated) rate-quality function 704 for a second frame (j=j₀+1) are piece-wise linear functions in-between adjacent points (adjacent in terms of encoding quality) included in the quality-rate table. The aggregated quality-rate function R(q) 705 (given by equation (1)) is also piece-wise linear and the target quality q_{T} is thus obtained by the intersection of R(q) and the total available transmission bits R_{N}. Once the target quality is determined the encoding data volume (or encoding data rate) for each audio frame is given by the quality-rate functions 703, 704, i.e., r₀ (q_{T}) and r₁(q_{T}) which are indicated on the second axis 702 in FIG. 7.

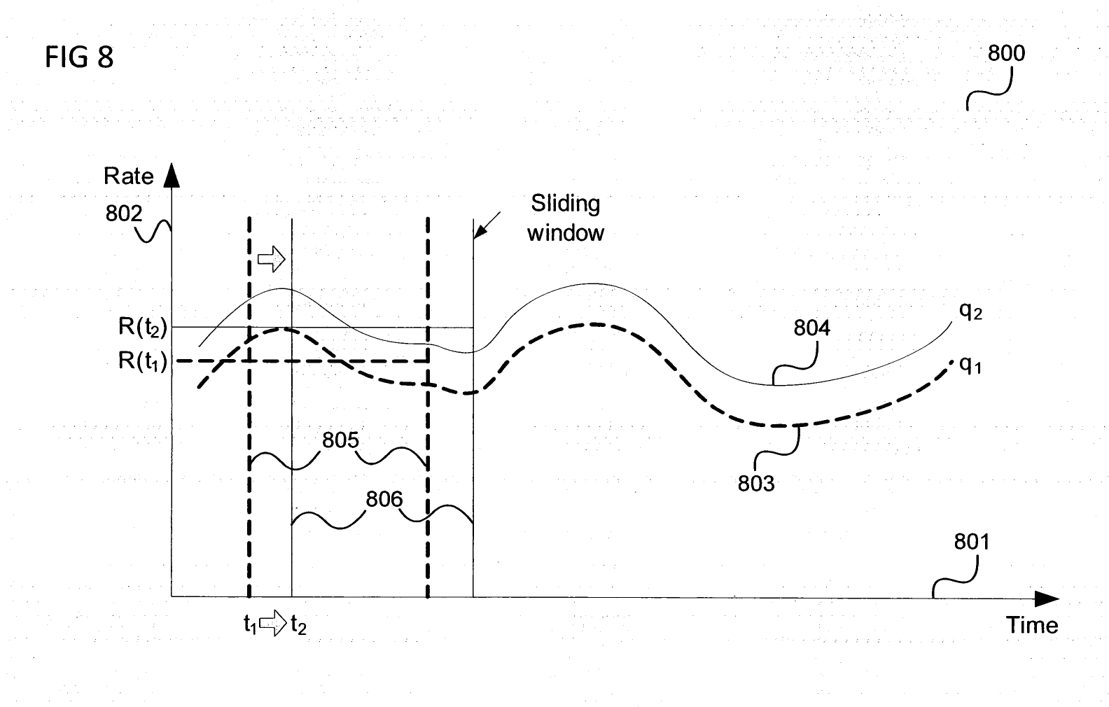

According to one embodiment, the rate controller 307 performs the target quality selection periodically during the streaming process in order to cater for the potential bandwidth fluctuation of the communication channel offered by the communication network 312 for the streaming. This is illustrated in FIG. 8 with an example.

FIG. 8 shows a data rate-time diagram 800.

Time increases along a first axis 801 and rate increases along a second axis 802.

The required encoding data volume (in other words the bit consumption) for streaming at a first quality q₁ at a certain time is indicated by a first graph 803 and the required encoding data volume (in other words the bit consumption) for streaming at a second quality q₁ at a certain time is indicated by a second graph 804.

In this example, at time t₁ the target quality is selected as q₁ such that the total bits consumption for the streaming of the frames in the sliding window starting at t₁ (indicated by dashed lines 805) is under the constraint of a current measured available bandwidth R(t₁). The target quality is updated at time t₂ again. Since it is assumed that the available bandwidth is increased to R(t₂) at time t₂ the target quality is adjusted to q₂ accordingly such that the total bits consumption for the streaming of the frames in the sliding window starting at t₂. (indicated by solid lines 806) is under the constraint R(t₂).

The effectiveness of the embodiment described above may be verified by simulation.

For example, for a simulation, MPEG-4 SLS (with an AAC core running at 32 kbps/channel) is used as the FGS audio codec and the rate-quality table 305 is generated at a step size of 32 kbps from the AAC core rate up to 256 kbps/channel. The qualities of the audio frames are measured in minimum MNR. The available bandwidth is set to 96 kbps. For example, the quality of streamed audio of three different cases are simulated: CBR streaming at 96 kbps, streaming according to the embodiment as described above with sliding window length 20, and streaming according to an embodiment as described above with a sliding window length of 200. In the simulation, the target quality is updated for every audio frame in the streaming according to the embodiment as described above. From the result it can be seen that the embodiment as described above leads to much smoother streamed audio quality, and the qualities of critical frames are dramatically improved. It can also be seen from simulation that a longer sliding window leads to smoother streamed audio quality. However, in practical application, care should be taken to avoid using a sliding window that is too long as smoothing streamed audio quality within an over-lengthy sliding window may not only increase the complexity of the target quality calculation, but also introduce bit-rate fluctuation over a large time-scale which may plague the buffer control of the streaming system.

The bandwidth estimator 308 may be seen to play an important role, in the embodiment for a streaming system as described above. The accuracy of the bandwidth estimator decides, to a large degree, the degree of match between data rate of the streamed audio and available bandwidth of the communication network 312. Any mismatch between these two may either result in under-utilization of communication network resources which is inefficient, or in over-utilization which increases the chance of packet delivery failure and eventually deteriorate the streaming quality.

Other than this accuracy requirement, it is also desirable that the output of the bandwidth estimator 308 should be smooth enough to avoid quality fluctuation in the streamed audio, and meanwhile respond fast enough when the communication network conditions change so that the streaming server (i.e. the transmitter 301) always utilizes the communication network resources safely and efficiently. The selection of the bandwidth estimator 308 also may also depend on the actual communication network used for the streaming service whereby elements to consider include the rate/congestion control protocols employed in the streaming server, network gateway designs, and network QoS (Quality of Service) parameters, etc.

According to one embodiment, the streaming service is provided using TCP/IP (Transport Control Protocol/IP Protocol) for communicating via the communication network 312 and there is no network parameter feedback from intermediate nodes of the communication network 312 so that the only information available for bandwidth estimation is from both ends of the communication network 312, i.e. the transmitter 301 and the receiver 302. This may be typical setup for a general purpose communication network such as the Internet. In this situation, the available bandwidth for streaming follows the TCP throughput function given by

$$T = \frac{s}{R \sqrt{\frac{2 p}{3}} + {t}_{RTO} ( 3 \sqrt{\frac{3 p}{8}} ) p ( 1 + 32 {p}^{2} )} ,$$

where s is the packet size, R is the round-trip time, p is the steady-state loss event rate, and t_{RTO} is the TCP retransmit timeout value.

This can for example be used by the bandwidth estimator 308 to estimate the available streaming bandwidth. However, it should be noted that this choice of the type of bandwidth estimator is only an example.

The adaptive audio streaming in accordance with the various embodiments maintains constant audio quality as much as possible during a streaming session to minimize the audio quality variance. It reserves available streaming bits during non-critical audio frames and uses them in streaming of critical audio frames, resulting in improved quality of the critical audio frames. Furthermore, it adapts the rate/quality of the streamed audio based on the available network bandwidth to avoid under-utilizing or over-utilizing the network resource.

In accordance with the various embodiments, the quality adaptation is done based on information from a rate-quality table generated from audio encoder, and real-time network condition during the streaming session.

The quality adaptation problem according to various embodiments can be seen to be based on simple linear interpolation that can be implemented with very low computational costs.

The adaptive streaming system according to an embodiment improves the audio streaming quality by reducing the quality variation during streaming, and boosting the quality of critical audio frames. This further leads to smoother audio playback during streaming since the demanded bandwidth is adapted to the available bandwidth in real-time during streaming.

The adaptive streaming system according to an embodiment further enables the service provider to use only one copy of FGS audio file to cater for users with different service preferences and network conditions. This reduces both implementation and running cost compared with conventional methods based on multiple copies of different quality/rate for the same contents.

The quality adaptation according to various embodiments is therefore suitable and applicable for multimedia streaming service over Internet (such as Internet audio) and over wired or wireless (including Mobile) networks.

According to one embodiment, the buffer level of the receiver 302 is considered. This may be done to avoid receiver buffer level staggering to a randomly low level and underflow during bursts of critical frames that have higher-than-average frame sizes. Embodiments taking into account the buffer level of the receiver 302 are described in the following.

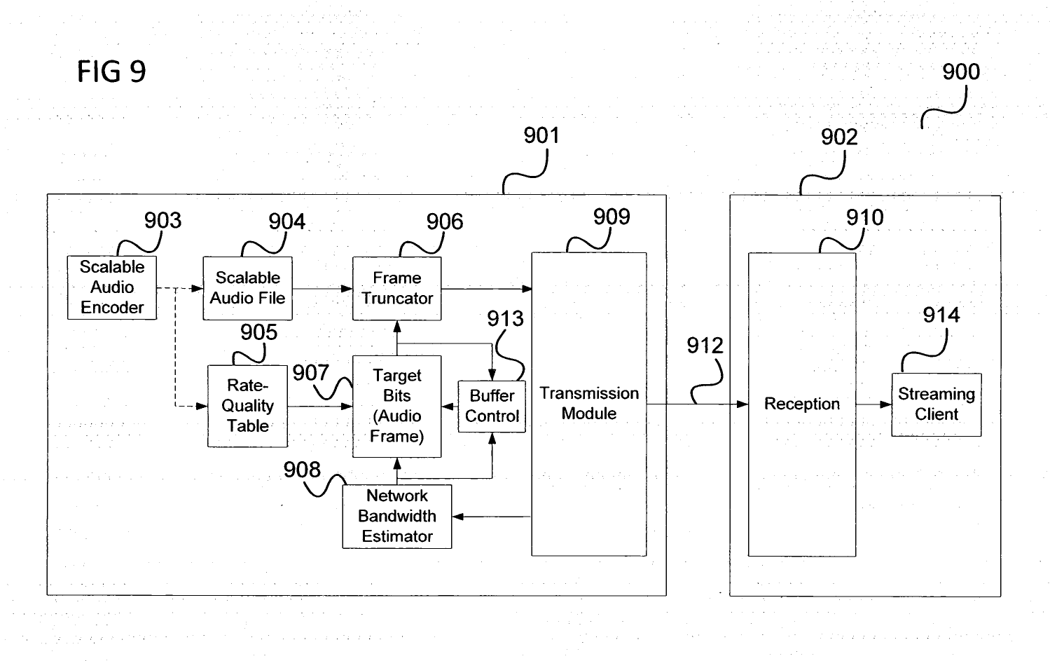

In an adaptive streaming system, since the streamed audio bit-streams are of variable bit-rate in nature and hence their bit-rate may not necessarily match the available network bandwidth at all time, FIFO (first-in-first-out) buffers may be utilized in both the transmitter (i.e. the streaming server) 301 and the receiver (including the streaming client) 302 to absorb the mismatch between the audio bit-rate and the actual communication network throughput in order to ensure smooth playback. Since such buffers have only limited length, a buffer control is used according to one embodiment to maintain appropriate buffer levels for these buffers to avoid overflow (i.e. the case that data is supplied to a full buffer) which may cause data loss or buffer underflow (i.e. the case that an empty buffer is to provide data) which may cause discontinuity in audio playback. In case that only the available streaming bandwidth is considered as a constraint in determining the streaming bit-rate (i.e. the encoding data volume of the frames) buffer constraints may be violated during a streaming session. To avoid this, a buffer control is introduced according to an embodiment. This is illustrated in FIG. 9.

FIG. 9 shows a communication arrangement 900 according to an embodiment.

The communication arrangement 900 includes, similarly to the communication arrangement 300 described above with reference to FIG. 3, a transmitter 901 and a receiver 902 connected via a communication network 912. The transmitter 901 includes a scalable audio encoder 903 providing a scalable audio file 904 and a rate-quality table 905. The transmitter 901 further includes a frame truncator 906 receiving the scalable audio file 904 as input and a rate controller 907 receiving the rate-quality table 905 as input. The transmitter 901 further includes a network bandwidth estimator 908 and a transmitting module 909. The receiver 902 includes a receiving module 910 and a streaming client 911.

In addition, the transmitter 901 includes a buffer controller 913 connected to the output of the network estimator 908, and both the output and an input of the rate controller 907.

The rate controller 913 selects the target quality of the streamed audio based on information from both the rate-quality model 905 and the available network bandwidth estimated by the bandwidth estimator 908. Meanwhile, the selection to meets the conditions as set by the rate control. Once the target quality is selected, the data of the scalable audio file 904 is truncated accordingly and the resulting data are sent via the communication network 912 for streaming to the streaming client 914.

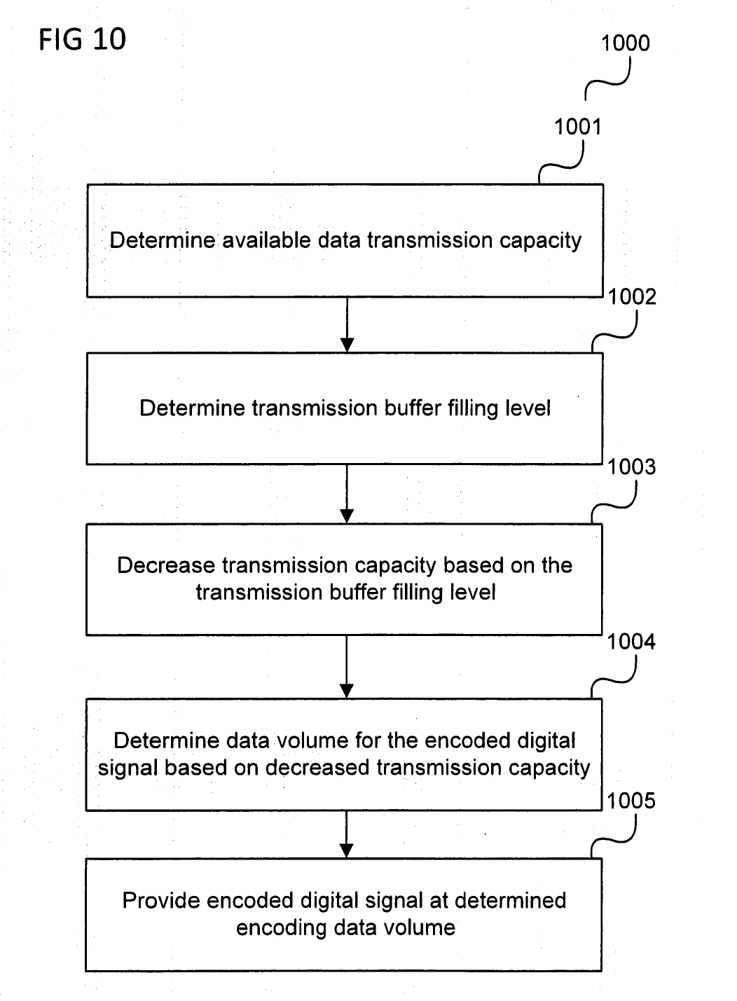

According to one embodiment, a method for providing an encoded digital signal is carried out as illustrated in FIG. 10.

FIG. 10 shows a flow diagram 1000 according to an embodiment.

The flow diagram 1000 illustrates a method for providing an encoded digital signal.

In 1001, a data transmission capacity available for transmitting the encoded digital signal from a transmitter to a receiver is determined.

In 1002, a transmission buffer filling level of the transmitter is determined.

In 1003, a decreased transmission capacity is calculated by decreasing the transmission capacity based on the transmission buffer filling level.

In 1004, a data volume for the encoded digital signal is determined based on the decreased transmission capacity.

In 1005, the encoded digital signal is provided at an encoding quality such that the encoded digital signal has the determined data volume.

According to one embodiment, in other words, the transmitter buffer level is taken into account when determining the encoding data volume to be used for a digital signal (e.g. for a plurality of data frames). According to one embodiment, the encoding quality at which the encoded digital signal is provided is determined with the method described above with reference to FIG. 1. In other words, according to one embodiment, the encoding quality is determined based on the multi-frame relationship determined as described above with reference to FIG. 1. For example, the encoding quality is determined as the encoding quality corresponding to the determined data volume (as encoding data volume) in accordance with the multi-frame relationship. In other words, the method described with reference to FIG. 1 and the method described with reference to FIG. 10 may be combined. The same holds for corresponding devices.

According to one embodiment, decreasing the transmission capacity includes decreasing the transmission capacity by the transmission buffer filling level scaled with a pre-determined scaling factor.

According to one embodiment, determining the available data transmission capacity for transmitting the encoded digital signal includes estimating the available bandwidth of a communication channel between the transmitter and the receiver.

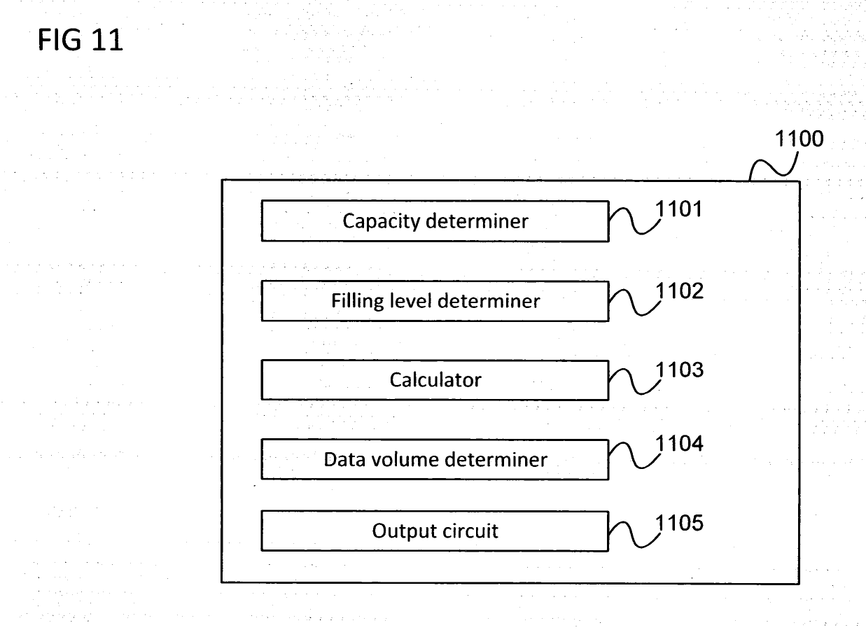

The method illustrated in FIG. 10 is for example carried out by a device as illustrated in FIG. 11.

FIG. 11 shows a device for providing an encoded digital signal 1100.

The device 1100 includes a capacity determining circuit 1101 configured to determine a data transmission capacity available for transmitting the encoded digital signal from a transmitter to a receiver and a filling level determining circuit 1102 configured to determine a transmission buffer filling level of the transmitter.

The device 1100 further includes a calculating circuit 1103 configured to calculate a decreased transmission capacity by decreasing the transmission capacity based on the transmission buffer filling level and a data volume determining circuit 1104 configured to determine a data volume for the encoded digital signal based on the decreased transmission capacity.

Additionally, the device 1100 includes an output circuit 1105 configured to provide the encoded digital signal at an encoding quality such that the encoded digital signal has the determined data volume.

It should be noted that embodiments described in the context of one of the methods for providing an encoded digital signal are analogously valid for the other method for providing an encoded digital signal and for the devices for providing an encoded digital signal and vice versa.

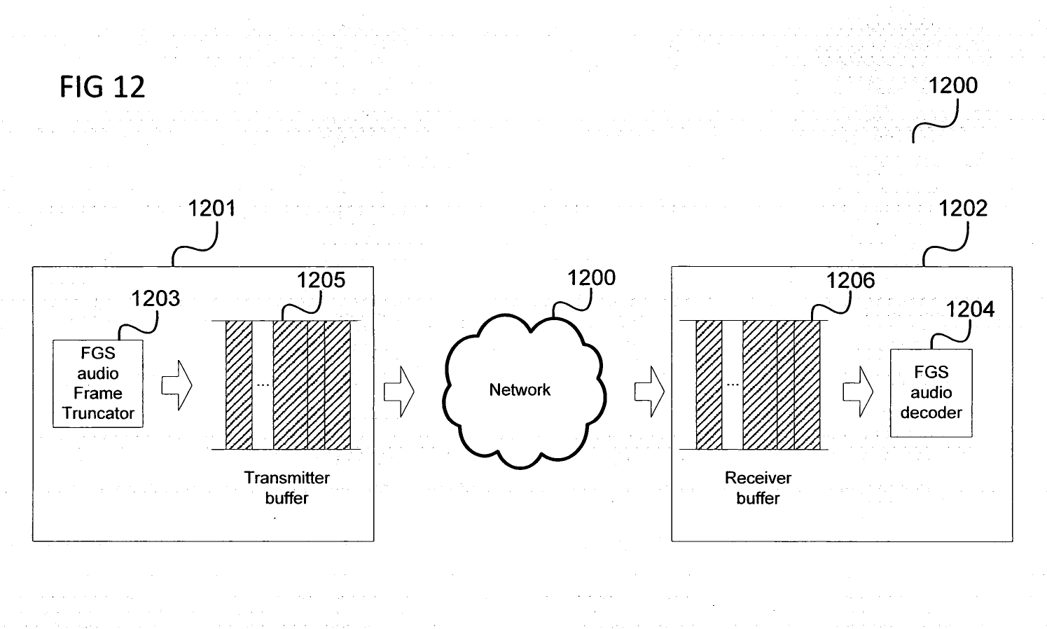

According to one embodiment, FIFO buffers are used in both the transmitter (streaming server) 901 and the receiver (receiver buffer) 902 to absorb discrepancies between the rate of the VBR audio bit-stream and the actual network throughput. This is illustrated in FIG. 12.

FIG. 12 shows a communication arrangement 1200 according to an embodiment.

The communication arrangement 1200 includes a transmitter 1201 for example corresponding to transmitter 901 and a receiver 1202 for example corresponding to the receiver 1202 connected via a communication network 1207. The transmitter includes a frame truncator 1203 for example corresponding to frame truncator 906 and the receiver includes an audio decoder 1204 (which is for example part of the streaming client 914).

The transmitter 1201 includes a transmit buffer 1205 and the receiver includes a receiver buffer 1206. The transmitter 1201 sends data to the communication network 1207 via the transmitter buffer 1205 and the transmitter 1202 receives data from the communication network via the receiver buffer 1206.

The transmitter buffer 1205 and the receiver buffer 1206 are FIFO (first in-first out) buffers.

FIG. 12 can be seen to illustrate a network model of the adaptive streaming system as illustrated in FIGS. 3 and 9. As can be seen from FIG. 12, the task of buffer control is to properly control the data rates that audio data enter and leave the buffers 1205, 1206 so that the buffers 1205, 1206 do not get underflowed (i.e. data is to leave an empty buffer) or overflowed (i.e. data is to enter a full buffer).

In the case of file-based streaming (unconstrained streaming) audio data to be streamed is pre-encoded and stored on a disk and hence there is no constraint on the rate that audio data enter the transmitter buffer 1205. In this case the buffer control in the transmitter buffer 1205 is not an issue and there is only a need to consider the receiver buffer 1206.

For a situation of live streaming (constrained streaming) the audio data is generated in real-time during streaming and as a result they have to enter the transmitted buffer 1205 in a constrained rate. In this case the buffer control needs to be considered at both buffers 1205, 1206. However, receiver side buffer 1206 underflow is only considered because receiver/transmitter buffer overflow can be easily avoided if sufficient memory is available, and transmission side buffer underflow can be solved by either reducing the transmission rate or using stiff bits.

Regarding the buffer level calculation of the receiver buffer 1206, the audio data being streamed is assumed to have a constant frame rate F in frame/sec, and each frame has a frame size of rᵢ bits, i=0, 1 . . . . Meanwhile, it is assumed that at each frame interval i the communication network 1207 transmits in total Cᵢ bits of data from the transmitter 1201 to the receiver 1202. To simplify the problem, it is assumed that there is no transmission delay and transmission error so that the bits being moved out from the transmitter buffer 1205 reach the receiver buffer 1206 immediately. Furthermore, an initial receiver side delay of Δ frames is assumed, i.e., the receiver 1202 waits for Δ frames before removing the first frame from the receiver buffer 1206 after it is received, and there is no other delay present in the streaming system. Under these assumptions, the transmitter buffer level B^{T} (i) and receiver buffer level B^{R} (i) at frame interval i are given respectively as:

$${B}^{T} ( i ) = {\sum }_{j = 1}^{i} {r}_{j} - {\sum }_{j = 1}^{i} {c}_{j} , \\ {B}^{R} ( i ) = \{ \begin{matrix}{\sum }_{j = 1}^{i} {c}_{j} - {\sum }_{j = 12}^{i - Δ} {r}_{j} , & i \geq Δ ; \\ {\sum }_{j = 1}^{i} {c}_{j} , & otherwise .\end{matrix} \qquad ( 4 )$$

That is, the transmitter buffer level is simply the total number of bits being generated from the encoder minus the total bits being transmitted, and the receiver buffer contains all the received bits minus those of the decoded frames. It should be noted that due to the initial receiver side delay at time i only (i−Δ) frames have been decoded. Here it is assumed that there is no transmitter buffer underflow to preserve the linearity of transmitter side buffer level calculation.

Combining the transmitter buffer level at time i and the receiver buffer level at time i+Δ gives

$$\begin{matrix}{B}^{R} ( i + Δ ) = {\sum }_{j = 1}^{i + Δ} {c}_{j} - {\sum }_{j = 1}^{i} {r}_{j} \\ = {\sum }_{j = i + 1}^{i + Δ} {c}_{j} - ( {\sum }_{j = 1}^{i} {r}_{j} - {\sum }_{j = 1}^{i} {c}_{j} ) \\ = {\sum }_{j = i + 1}^{i + Δ} {c}_{j} - {B}^{T} ( i ) .\end{matrix} \qquad ( 5 )$$

To prevent the receiver buffer 1206 from underflowing the right-hand side of equation (5) should be kept always greater than zero, i.e., the transmitter buffer size should not exceed Σⱼ₌ᵢ₊₁^{i+Δ} Cⱼ. It should be noted that given that there is sufficient memory available at the transmitter 1201 and receiver, this constraint is actually imposed by the initial delay Δ and the network condition Cⱼ rather than by memory considerations. Therefore the amount of Σⱼ₌ᵢ₊₁^{i+Δ} Cⱼ may also be referred to as effective buffer size to reflect this fact.

Since the prevention of receiver buffer underflow is equivalent to prevention of encoder buffer level from exceeding the effective buffer size, according to one embodiment, the transmitter buffer level is incorporated in the rate control equation in an appropriate manner to prevent it from going too high. This can be implemented by modifying equation (1) as follows so that the overall bit-budget for each sliding window is further constrained by the transmission buffer level:

$${\sum }_{j = 1}^{i + L} {r}_{j} ( {q}_{T} ) = {LFR}_{i} - α \cdot {B}^{T} ( i ) \qquad ( 6 )$$

where 0<α is a predefined constant and Rᵢ is the available bit budget for the transmission of the ith frame (assumed to be constant for all frames of the sliding window).

In other words, the transmission capacity provided by the communication network 1207 as for example estimated by bandwidth estimator 908, is decreased based on the transmission buffer filling level for purposes of encoding quality determination.

It can be seen that with equation (6)

$$\begin{matrix}{B}^{T} ( i + L ) = {B}^{T} ( i ) + {\sum }_{j = 1}^{i + L} {r}_{j} ( {q}_{T} ) - {\sum }_{j = 1}^{i + L} {c}_{j} \\ = {B}^{T} ( i ) + {LFR}_{i} - α {B}^{T} ( i ) - {\sum }_{j = i}^{i + L} {c}_{j} , \\ \approx ( 1 - α ) {B}^{T} ( i ) ,\end{matrix} \qquad ( 7 )$$

if target quality q_{T} is used for the whole sliding window and the bandwidth estimation made at frame index i is sufficiently close to actual amount of date being transferred within the sliding window. As a result, the transmitter buffer level will be pulled towards zero at the end of each sliding window and the larger the value of the constant α, the transmitter buffer level will be pulled towards zero more aggressively. Therefore, the value of α plays an important role in determining the aggressiveness of the buffer control algorithm. As a rule of thumb, care should be taken to avoid using an overlarge α as it will discourage buffer usage and may lead to suboptimal quality at critical audio frames; on the other hand, α should be large enough so that the transmitter buffer level never exceeds the effective buffer level to avoid decoder buffer underflow. The minimum value of α can be determined from the network characters as well as other streaming parameters such as the amount of the initial buffer size and the length of the sliding window.

Mathematically, it can be shown that the transmitter buffer level is bounded by:

$${B}^{T} ( i ) < \frac{{LFR}_{ma x}}{α} , \qquad ( 8 )$$

where Rₘₐₓ=max(Rᵢ) is the maximum possible available bandwidth for streaming. Therefore, receiver buffer underflow can be completely avoided if it can be guaranteed that the effective buffer size is larger than this upper bound for the transmitter buffer, i.e., that

$${\sum }_{j = i + 1}^{i + Δ} {c}_{j} \geq \frac{{LFR}_{ma x}}{α} > {B}^{T} ( i ) . \qquad ( 9 )$$

Unfortunately, this condition may not be very helpful in practice where the actual amount of data Cⱼ being transmitted from frame index i to i+Δ is, in general, unknown a priori, in particular for a channel with variable bit rate. However, if it is assumed that the variable bit rate channel is characterized with a minimum bandwidth Rₘᵢₙ, then Σⱼ₌ᵢ^{i+Δ} Cⱼ≧ΔFRₘᵢₙ, and equation (7) is satisfied as long as

$$\begin{matrix}Δ {FR}_{m i n} \geq \frac{1}{α} {LFR}_{ma x} , \\ or & ( 10 ) \\ α \geq \frac{L}{Δ} \cdot \frac{{R}_{m ax}}{{R}_{m i n}} . & ( 11 )\end{matrix}$$

Therefore, inequality (9) can be used as design guideline for selecting α once other design parameters such as the initial delay Δ and the sliding window length L are fixed, and the range of the bandwidth variation of the streaming network is known. In a simpler case if the channel has constant bit rate (CBR), resulting in Rₘᵢₙ=Rₘₐₓ, equation (11) simplifies to

$$α \geq \frac{L}{Δ} . \qquad ( 12 )$$

It should be noted that the above bound for α (according to equation (11)) is a bit pessimistic and in practical application it may be possible to use a smaller value of α without leading to receiver buffer underflow.

The effectiveness of the buffer control as described can be verified by simulation. The buffer control algorithm may be integrated with the adaptive streaming system according to the embodiment described above where MPEG-4 SLS (with an AAC core at 32 kbps/channel) is used as the FGS audio codec and the rate-quality table is generated at a step size of 32 kbps from the AAC core rate up to 256 kbps/channel. The qualities of the audio frames are measured in minimum MNR. CBR channel is assumed in this simulation where the available bandwidth is set at 96 kbps. The sliding window size for the adaptive streaming system is set to 10 frames, i.e., L=10 and the target quality update is performed for each frame during streaming. The size of the receiver buffer is set to 20 kilobits and the receiver 902 starts to decode the first audio frame as long as the receiver buffer 1206 is full at beginning. Given the transmission data rate of 96 kbps, this is approximated to 20 kilobits/96 kbps=208.3 ms of delay or roughly 10 SLS frames, i.e., Δ=10.

As can be seen from a comparison between α=0 (no buffer control) and α=1 for a testing sequence buffer underflow may start at a certain frame and exaggerates with the progress of the streaming session when there is no buffer control. However, the buffer underflow problem may be solved with the introduction of the buffer control. In addition, from the quality data it can be seen that the buffer control only introduces negligible impact to the streaming quality.

According to an embodiment, as described above, a method and system for streaming scalable audio, in particularly, adaptively streaming fine grain scalable audio in a network with varying bandwidth is provided wherein quality of each audio frame in the audio stream being streamed is determined based on a function of two or more Rate-Quality data measured for each audio frame from a given window in which said frame being streamed resides. A method of buffer control is also introduced to manage the receiver underflow problem.

While the invention has been particularly shown and described with reference to specific embodiments, it should understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

The following documents are cited in the above description
[1] J. Lin and A. Ortega, “Bit-rate Control using piecewise approximation rate-distortion characteristics,” IEEE Trans. Circuits Syst. Video Technol., vol. 8, no. 4, pp. 446-459, August 1998.
[2] L. Zhao, J. W. Kim, and C.-C. Kuo, “MPEG-4 FGS video streaming with constant-quality rate control and differentiated forwarding,” in SPIE VCIP, January 2002, pp. 230-241.
[3] M. Dai et al, “Rate-Distortion Analysis and Quality Control in Scalable Internet Streaming”, IEEE Transactions on Multimedia, Vol. 8, No. 6, December 2006.

1. A method for providing an encoded digital signal comprising
determining, for each data frame of a plurality of data frames of a digital signal, a plurality of pairs of an encoding data volume and an encoding quality, wherein each pair of an encoding data volume and an encoding quality specifies the encoding data volume required for achieving the encoding quality;
determining for each data frame at least one or more interpolations between the plurality of determined pairs;
determining a multi-frame relationship between encoding quality and encoding data volume required to encode the plurality of data frames at the encoding quality based on a combination of the at least one or more interpolations for the plurality of data frames;
determining an encoding quality for the plurality of data frames based on the relationship; and
providing at least one data frame of the plurality of data frames encoded at the determined encoding quality.

2. Method according to claim 1, wherein the relationship specifies for each encoding quality of a plurality of encoding qualities a corresponding encoding data volume required to encode the plurality of data frames at the encoding quality.

3. Method according to claim 2, wherein the encoding quality for the plurality of data frames is determined such that the encoding data volume corresponding to the determined encoding quality according to the relationship fulfils a predetermined criterion.

4. Method according to claim 3, wherein the criterion is that the encoding data volume is below a pre-determined threshold.

5. Method according to claim 4, wherein the threshold is based on a maximum data rate.

6. Method according to claim 1, wherein the multi-frame relationship is determined based on a combination of the at least one or more interpolations for at least two different data frames of the plurality of data frames.

7. Method according to claim 1, wherein the at least one interpolation of a data frame of the plurality of data frames is an interpolation of the plurality of encoding data volume and encoding quality pairs of the data frame.

8. Method according to claim 1, wherein the at least one interpolation of a data frame of the plurality of data frames is a linear interpolation of the plurality of encoding data volume and encoding quality pairs of the data frame.

9. Method according to claim 1, wherein the plurality of data frames are a plurality of successive data frames.

10. Method according to claim 9, wherein the at least one data frame of the plurality of data frames provided encoded at the determined encoding quality comprises the first data frame of the plurality of successive data frames encoded at the determined encoding quality.

11. Method according to claim 9, further comprising determining a further encoding quality to be used for a further plurality of successive data frames comprising the plurality of data frames without the at least one data frame provided encoded at the determined encoding quality.

12. Method according to claim 1, wherein each interpolation of the at least one or more interpolations between the plurality of determined pairs for a data frame is an interpolated pair of an encoding data volume and an encoding quality specifying the encoding data volume required for achieving the encoding quality for the data frame.

13. Method according to claim 1, wherein the multi-frame relationship is determined based on a summing of the encoding data volumes required for achieving an encoding quality for different data frames for the same encoding quality.

14. Method according to claim 13, wherein the result of the summing is specified by the relationship for an encoding quality as a corresponding encoding data volume required to encode the plurality of data frames at the encoding quality.

15. Method according to claim 1, wherein the multi-frame relationship is a piecewise linear correspondence between encoding quality and encoding data volume required to encode the plurality of data frames at the encoding quality.

16. Method according to claim 1, wherein the plurality of pairs of an encoding data volume and an encoding quality for each data frame are generated by measuring, for each of a plurality of encoding data volumes, the encoding quality achieved when encoding the data frame using the encoding data volume.

17. Method according to claim 1, wherein the digital signal is an audio signal.

18. A device for providing an encoded digital signal comprising
a first determining circuit configured to determine, for each data frame of a plurality of data frames of a digital signal, a plurality of pairs of an encoding data volume and an encoding quality, wherein each pair of an encoding data volume and an encoding quality specifies the encoding data volume required for achieving the encoding quality;
an interpolator configured to determine for each data frame at least one or more interpolations between the plurality of determined pairs;
a combiner configured to determine a multi-frame relationship between encoding quality and encoding data volume required to encode the plurality of data frames at the encoding quality based on a combination of the at least one or more interpolations for the plurality of data frames;
a second determining circuit configured to determine an encoding quality for the plurality of data frames based on the relationship; and
an output circuit providing at least one data frame of the plurality of data frames encoded at the determined encoding quality.

19. A method for providing an encoded digital signal comprising
determining a data transmission capacity available for transmitting the encoded digital signal from a transmitter to a receiver;
determining a transmission buffer filling level of the transmitter;
calculating a decreased transmission capacity by decreasing the transmission capacity based on the transmission buffer filling level;
determining a data volume for the encoded digital signal based on the decreased transmission capacity;
providing the encoded digital signal at an encoding quality such that the encoded digital signal has the determined data volume.

20. The method according to claim 19, wherein decreasing the transmission capacity comprises decreasing the transmission capacity by the transmission buffer filling level scaled with a pre-determined scaling factor.

21. (canceled)

22. (canceled)
